(19) United States
(12) Patent Application Publication
(10) Pub. No.: US 2002/0117825 A1
(43) Pub. Date: Aug. 29, 2002

(54) Scooter having a rear wheel hood mounted on a rear wheel thereof

(76) Inventor: Nina Ho, Taichung (TW)

Correspondence Address: FINNEGAN, HENDERSON, FARABOW, GARRETT &, DUNNER LLP, 1300 I STREET, NW, WASHINGTON, DC, 20005, US

(21) Appl. No.: 09/791,652

(22) Filed: Feb. 26, 2001

(51) Int. Cl. B62M 1/00

(52) U.S. Cl. 280/87.041; 280/762

(57) ABSTRACT

A scooter includes a horizontal footrest frame and a rear wheel-mounting member fixed to a rear end of the footrest frame. The wheel-mounting frame includes two spaced apart plates which define a wheel-accommodating space therebetween. A rear wheel is disposed between and is journalled to the plates. A curved spring arm is disposed behind the rear wheel, and has a lower section fixed to distal ends of the plates, and an upper section which extends upwardly and frontwardly from the lower section. A rear wheel hood is disposed circumferentially around and above the rear wheel and the spring arm, and has a front portion, an apex portion, and a rear portion that is fixed to and that is urged by the upper section of the spring arm to define a clearance between the rear wheel and the rear wheel hood and to permit movement of the front portion of the rear wheel hood toward and away from the rear wheel such that an external force applied on the front portion of the rear wheel hood results in colliding of the front portion of the rear wheel hood against the rear wheel to provide a retarding force to counteract a forward movement of the rear wheel.

### BACKGROUND OF THE INVENTION

1. Field of the Invention

This invention relates to a scooter, more particularly to a scooter having a rear wheel hood mounted on a rear wheel thereof for braking the same.

2. Description of the Related Art

Referring to FIGS. 1 and 2, a conventional scooter according to U.S. Pat. No. 6,139,035 is shown to include a horizontal footrest frame 1, a rear wheel-mounting member 102, a rear wheel 2, and a rear wheel hood 3. The wheel-mounting member 102 is fixed to a rear end 101 of the footrest plate 1, and defines a wheel-accommodating space therein. The rear wheel 2 is disposed in the wheel-accommodating space, and is journalled to the wheel-mounting member 102. The rear wheel hood 3 is disposed circumferentially around and above the rear wheel 2, and has a front section 304 fixed to the rear end 101 of the footrest frame 1 via a fastener pin 301. A generally V-shaped spring arm 4 is disposed in front of the rear wheel 2, and has one end fixed to the rear end 101 of the footrest frame 1, and the other end biasing the front section 304 of the rear wheel hood 3 in such a manner that the rear wheel hood 3 is spaced apart from the rear wheel 2.

When braking the rear wheel 2, an external force is applied on the rear wheel hood 3 such that the inner surface 303 of the rear wheel hood 3 frictionally engages the rear wheel 2, thereby preventing rotation of the rear wheel 2. However, during the braking operation, the inner surface 303 of the rear wheel hood 3 engages the rear wheel 2 only at an apex portion thereof. As a consequence, a relatively large friction force is required for braking the rear wheel 2 and can result in skidding of the rear wheel 2.

### SUMMARY OF THE INVENTION

The object of this invention is to provide a scooter provided with a rear wheel hood that is adapted to overcome the aforesaid disadvantages associated with the conventional scooter.

Accordingly, a scooter of the present invention includes a horizontal footrest frame, a rear wheel-mounting member, a rear wheel, a curved spring arm, and a rear wheel hood. The rear wheel-mounting member is fixed to a rear end of the footrest frame, and includes two spaced apart plates which extend rearwardly from the footrest frame and which define a wheel-accommodating space therebetween. The rear wheel is disposed in the wheel-accommodating space, and is journalled to the plates. The curved spring arm is disposed behind the rear wheel, and has a lower section fixed to distal ends of the plates, and an upper section which extends upwardly and frontwardly from the lower section thereof. The rear wheel hood is disposed circumferentially around and above the rear wheel and the spring arm, and has a front portion, an apex portion, and a rear portion that is fixed to and that is urged by the upper section of the spring arm to define a clearance between the rear wheel and the rear wheel hood and to permit movement of the front portion of the rear wheel hood toward and away from the rear wheel such that an external force applied on the front portion of the rear wheel hood results in colliding of the front portion of the rear wheel hood against the rear wheel to provide a retarding force to counteract a forward movement of the rear wheel.

The rear wheel hood provides effective braking relative to the rear wheel and accordingly prevents skidding of the rear wheel.

### BRIEF DESCRIPTION OF THE DRAWINGS

These and other features and advantages of this invention will become apparent in the following detailed description of the preferred embodiment of this invention, with reference to the accompanying drawings, in which:

FIG. 1 is a schematic side view of a conventional scooter;

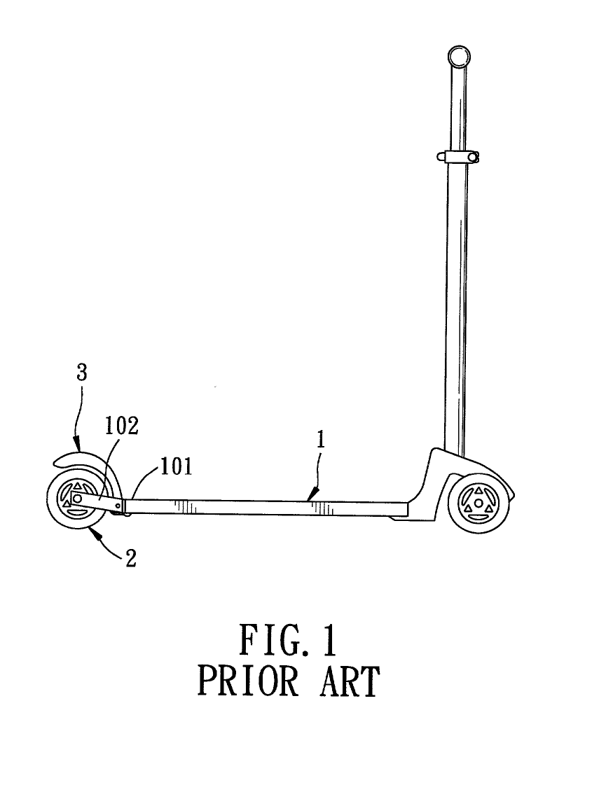

FIG. 2 is a fragmentary schematic side view of the conventional scooter, illustrating how a rear wheel hood acts on a rear wheel during a braking operation;

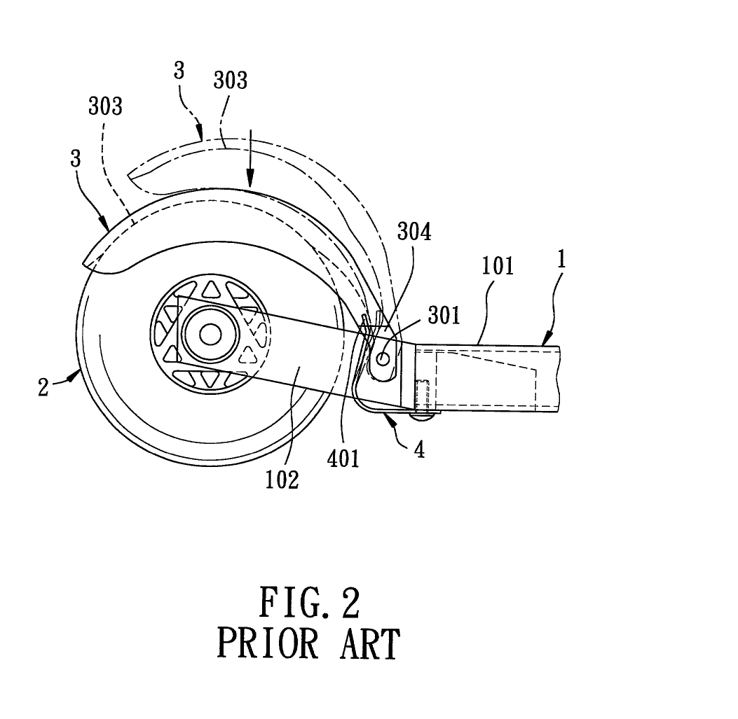

FIG. 3 is a fragmentary exploded perspective view of a preferred embodiment of a scooter according to the present invention;

FIG. 4 is a fragmentary sectional view of the preferred embodiment; and

FIG. 5 is a fragmentary sectional view of the preferred embodiment, illustrating how a rear wheel hood acts on a rear wheel upon application of an external force during a braking operation.

### DETAILED DESCRIPTION OF THE PREFERRED EMBODIMENT

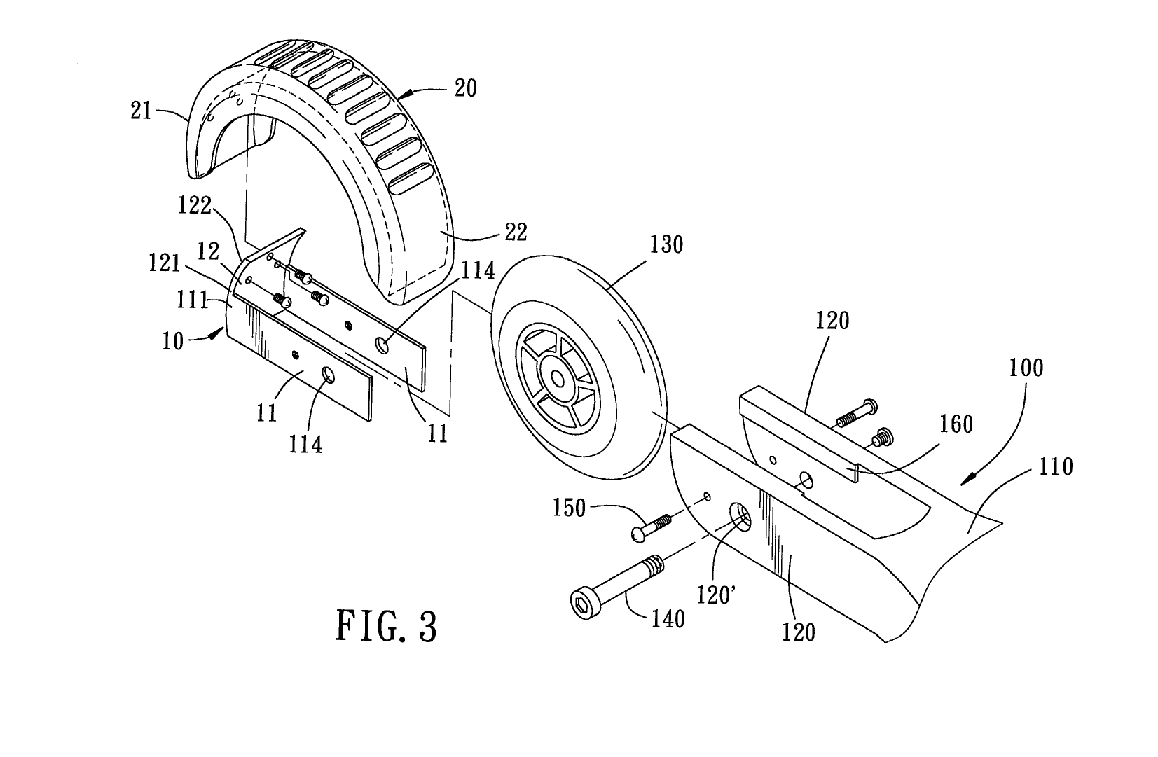

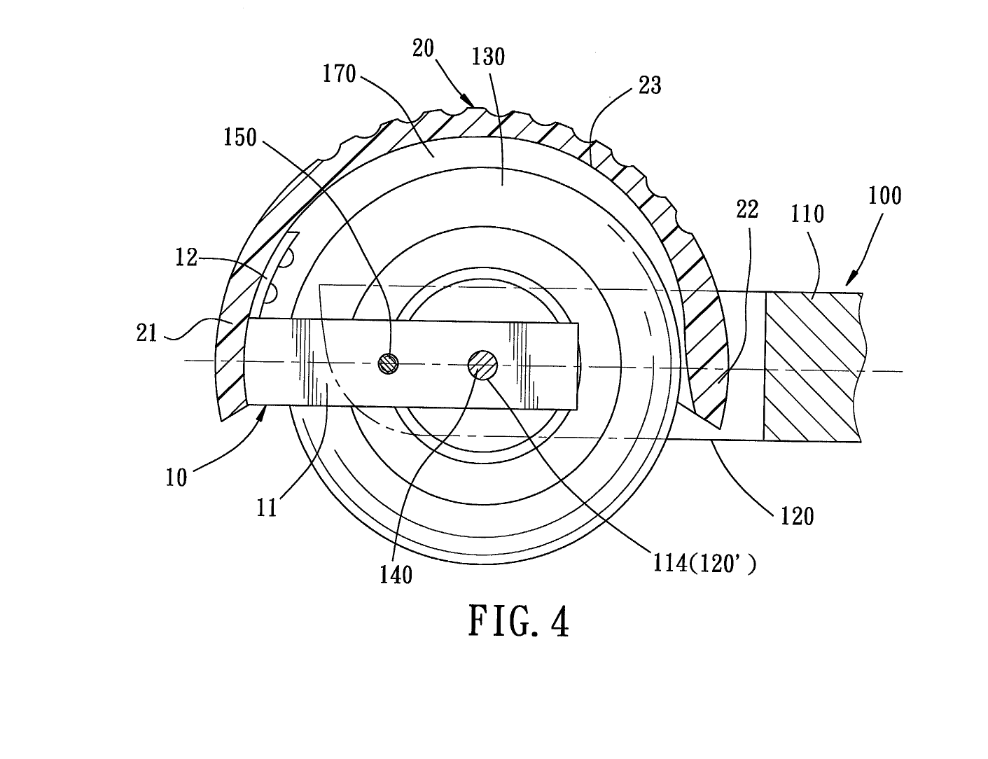

Referring to FIGS. 3 and 4, the preferred embodiment of a scooter according to the present invention is shown to include a horizontal footrest frame 100, a rear wheel-mounting member 10, a rear wheel 130, a curved spring arm 12, and a curved rear wheel hood 20.

As illustrated, the horizontal footrest frame 100 has a rear end 110 which defines two spaced apart rails 120. The rear wheel-mounting member 10 is fixed to the footrest frame 100 at the rear end 110 by means of two fastener screws 150, and includes two spaced apart plates 11 which extend rearwardly from the rear end 110 of the footrest frame 100 and define a wheel-accommodating space therebetween.

The rear wheel 130 is disposed between the accommodating space of the plates 11. An axle 140 extends through holes 114 in the plates 11, and holes 120′ in the rails 120 so as to journal the wheel 130 between the plates 11.

The spring arm 12 is disposed behind the rear wheel 130, and has a lower section 121 fixed to distal ends 111 of the plates 11, and an upper section 122 which extends upwardly and frontwardly from the lower section 121.

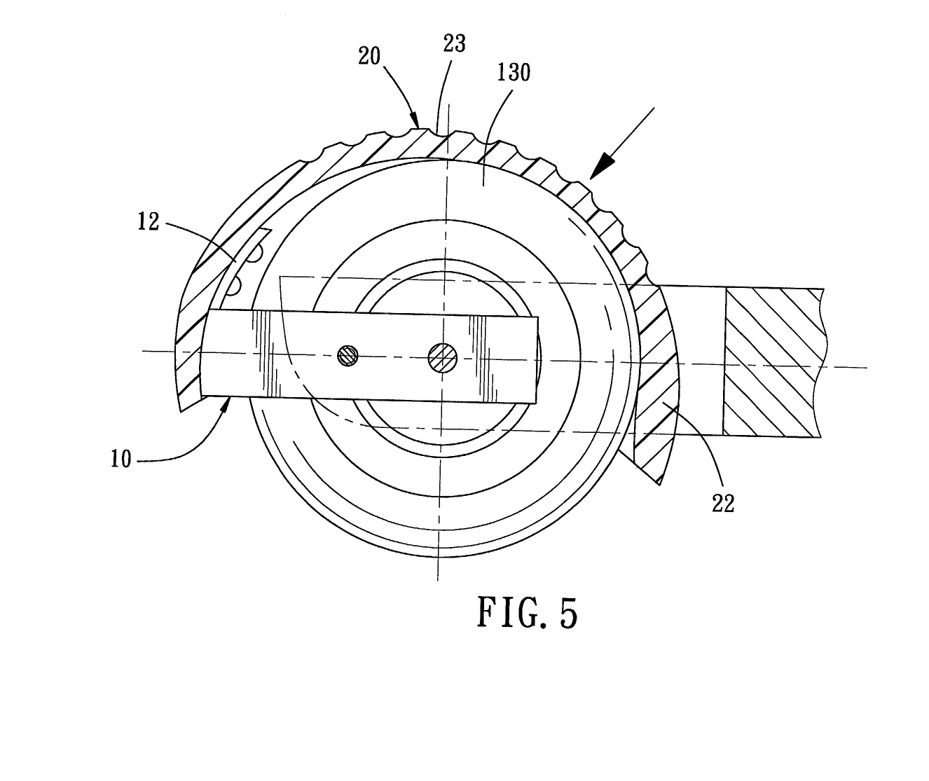

The rear wheel hood 20 is disposed circumferentially around and above the rear wheel 130 and the spring arm 12, and has a front portion 22, an apex portion 23, and a rear portion 21 fixed to the upper section 122 of the spring arm 12 and urged by the upper section 122 of the spring arm 12 to define a clearance 170 between the rear wheel 130 and the rear wheel hood 20. Under this condition, the front portion 22 of the rear wheel hood 20 is permitted to move toward and away from the rear wheel 130 such that when an external force is applied on the front portion 22 of the rear wheel hood 20, as best shown in FIG. 5, the latter collides against the rear wheel 130 to provide a retarding force to counteract a forward movement of the rear wheel 130. Since the retarding force is directly opposite to the forward movement of the rear wheel 130, an effective braking can be achieved and skidding of the rear wheel 130 as encountered in the prior art can be eliminated. Preferably the footrest frame 100 further has two plate-retaining flanges 160 integrally formed with the rails 120 to define two plate-retention grooves within which the plates 11 are secured with the assistance of the axle 140 and the fastener screws 150.

The clearance 170 defined between the rear wheel hood 20 and the rear wheel 130 gradually converges from the rear portion 21 of the rear wheel hood 20 toward the front portion 22 of the rear wheel hood 20 to facilitate collision of the front portion 22 of the rear wheel hood 20 against the rear wheel 130.

With this invention thus explained, it is apparent that numerous modifications and variations can be made without departing from the scope and spirit of this invention. It is therefore intended that this invention be limited only as indicated by the appended claims.

I claim:

1. A scooter comprising:
a horizontal footrest frame having a rear end;
a rear wheel-mounting member fixed to said footrest frame at said rear end, and including two spaced apart plates extending rearwardly therefrom and defining a wheel-accommodating space between said plates;
a rear wheel disposed between and journalled to said plates;
a curved spring arm disposed behind said rear wheel, and having a lower section fixed to distal ends of said plates, and an upper section extending upwardly and frontwardly from said lower section; and
a rear wheel hood disposed circumferentially around and above said rear wheel and said spring arm, having a front portion, an apex portion, and a rear portion fixed to and urged by said upper section of said spring arm to define a clearance between said rear wheel and said rear wheel hood and to permit movement of said front portion of said rear wheel hood toward and away from said rear wheel such that an external force applied on said front portion of said rear wheel hood results in colliding of said front portion of said rear wheel hood against said rear wheel to provide a retarding force to counteract a forward movement of said rear wheel.

2. The scooter as defined in claim 1, wherein said clearance gradually converges from said rear portion of said rear wheel hood toward said front portion of said rear wheel hood to facilitate collision between said front portion of said rear wheel hood and said rear wheel.
